(19) United States
(12) Patent Application Publication
(10) Pub. No.: US 2026/0315936 A1
(43) Pub. Date: Oct. 15, 2026

(54) DISPLAY ADJUSTMENT CORRESPONDING TO CRYPTOCURRENCY PROGRESSIVE AWARD

(71) Applicant: IGT, Las Vegas, NV (US)

(72) Inventors: Kevin HIGGINS, Reno, NV (US); Dwayne NELSON, Las Vegas, NV (US)

(73) Assignee: IGT, Las Vegas, NV (US)

(21) Appl. No.: 19/177,151

(22) Filed: Apr. 11, 2025

Related U.S. Application Data
(63) Continuation of application No. 17/410,954, filed on Aug. 24, 2021, now abandoned.

(51) Int. Cl. A63F 13/792

(52) U.S. Cl. CPC A63F 13/792

(57) ABSTRACT

Systems and methods are provided. Operations of systems include determining a first level progressive award that includes a first initial progressive award amount and a first additional amount funded by at least one of multiple wagers placed to initiate a first primary game on a first gaming device. Operations include determining a second level progressive award that includes a second initial progressive award amount and a second additional amount funded by either of the at least one of the wagers placed to initiate the first primary game on the first gaming device or a second one of the wagers placed to initiate a second primary game on one of the first gaming device or a second gaming device. Operations provide data corresponding to the first level progressive award and the second level progressive award to multiple gaming devices that includes the first gaming device and the second gaming device.

### BACKGROUND OF THE DISCLOSURE

Players enjoy playing slot games with one or more progressive awards as it gives them an opportunity to win a large award, which can potentially be life changing. Those players often are playing paytables with high volatility as some of the payback that is ultimately due to players may occur infrequently because it may be based upon the hit frequency of the progressive award. Given that these players may enjoy volatility, alternative techniques for providing volatility may be advantageous.

### BRIEF SUMMARY OF THE DISCLOSURE

Some embodiments are directed to a system includes a communication interface, a processor circuit and a memory coupled to the embodiments. The memory includes machine readable instructions that, when executed by the processor circuit, cause the processor circuit to determine a first level progressive award that includes a first initial progressive award amount and a first additional amount funded by at least one of multiple wagers placed to initiate a first primary game on a first gaming device, determine a second level progressive award that includes a second initial progressive award amount and a second additional amount funded by either of the at least one of the wagers placed to initiate the first primary game on the first gaming device or a second one of the wagers placed to initiate a second primary game on one of the first gaming device or a second gaming device. The processor circuit further provides data corresponding to the first level progressive award and the second level progressive award to multiple gaming devices that includes the first gaming device and the second gaming device. The first level progressive award is denominated in a first currency that is a base currency of a location of the first gaming machine and the second level progressive is denominated in a second currency that is different from the first currency.

Some embodiments are directed to methods that include operations. Such operations may include receiving wager contributions from multiple gaming machines that are participating in a multi-currency progressive award that includes a first level progressive award that is denominated in a first currency and a second level progressive award that is denominated in a second currency that is different from the first currency. Operations include updating a first award value of a first pool corresponding to the first level progressive award, determining if second level progressive award trigger event has occurred and, responsive to determining that the second level progressive award trigger event has occurred, updating a second award value of a second pool corresponding to the second level progressive award based on an escrow value in an escrow pool.

Operations include determining if an award payout is triggered. In response to the award payout being triggered, operations include sending a message to a cryptocurrency exchange management service to convert remaining first currency into the second currency. Operations further include resetting the first pool, second pool and escrow pool.

Some embodiments are directed to systems and methods that are configured to perform operations. Such operations include transmitting progressive wager data to a progressive award server. Operations further include receiving, from the progressive award server, data corresponding to a first level progressive award and a second level progressive award. In some embodiments, the first level progressive award is denominated in a first currency that is a base currency of a location of the gaming device and the second level progressive is denominated in a second currency that is different from the first currency. Some embodiments include displaying the first level progressive award in the first currency and the second level progressive award in the second currency.

### BRIEF DESCRIPTION OF THE DRAWINGS

FIG. 1 is a schematic block diagram illustrating a standalone progressive jackpot with one or more progressive pools and/or levels maintained by the EGM or game software itself according to some embodiments.

FIG. 2 is a schematic block diagram illustrating a progressive controller maintained and/or managed progressive jackpot with one or more progressive pools and/or levels maintained by the EGM or game software itself according to some embodiments.

FIG. 3 is a schematic block diagram illustrating a progressive controller maintained and/or managed progressive jackpot with one or more EGMs across multiple casino sites according to some embodiments.

FIG. 4 is a schematic view of a screenshot including payout opportunities corresponding to a progressive jackpot game according to some embodiments disclosed herein.

FIG. 5 is a schematic view of a screenshot including payout opportunities corresponding to a progressive jackpot game according to some embodiments disclosed herein.

FIG. 6 is a schematic block diagram of a cryptocurrency progressive game according to some embodiments disclosed herein.

FIG. 7 is a schematic block diagram illustrating cryptocurrency progressive management according to some embodiments disclosed herein.

FIG. 8 is a schematic view of a screenshot including payout opportunities corresponding to a progressive jackpot game according to some embodiments disclosed herein.

FIG. 9 is a schematic view of a screenshot 940 including payout opportunities corresponding to a progressive jackpot game according to some embodiments disclosed herein.

FIG. 10 is a depiction of an example receipt for the jackpot payment of a cryptocurrency win when paid in fiat currency according to some embodiments disclosed herein.

FIG. 11 is a schematic flow diagram that illustrates an example of a player presenting their blockchain address QR code, to be scanned by the casino and/or wide area progressive operator personnel, to initiate the transfer according to some embodiments.

FIG. 12 is a depiction of an example jackpot payment receipt for a cryptocurrency payment transfer receipt according to some embodiments disclosed herein.

FIG. 13 is a flow diagram illustrating operations and components for a progressive jackpot award deposit into a player’s resort wallet according to some embodiments.

FIG. 14 is a flow diagram illustrating operations and components for a progressive jackpot award annuity smart contract payment according to some embodiments.

FIG. 15 illustrates a casino management system including a plurality of gaming devices according to some embodiments herein.

FIG. 16 is a block diagram that illustrates various components of a computing device, which may embody or be included as part of the devices, systems, and/or components above, according to some embodiments.

FIG. 17 is a schematic block diagram illustrating various operations for a blockchain transaction recordation according to some embodiments.

FIG. 18 is a schematic flow diagram illustrating operations of a system for a cryptocurrency denominated progressive award according to some embodiments.

FIG. 19 is a schematic flow diagram illustrating operations of a system for a cryptocurrency denominated progressive award according to some embodiments.

FIG. 20 is a schematic flow diagram illustrating operations of methods and systems for a cryptocurrency denominated progressive award according to some embodiments.

### DETAILED DESCRIPTION OF THE DISCLOSURE

Embodiments provided herein may include another element of volatility to the experience. For example, some embodiments may denominate one or more progressive award values in a cryptocurrency. A fiat representation of the progressive award value(s) may then fluctuate based upon more variables than what players encounter in the field. For example, values may fluctuate based on contributions from play, hits and fluctuations in the underlying value of the cryptocurrency(s) the progressive pool values are denominated in.

Such an increase in volatility can be leveraged by new game themes that accentuate and emphasize use of cryptocurrency denominated progressives. This can be especially valuable to casino operators when particular cryptocurrencies are popular and are gathering media attention.

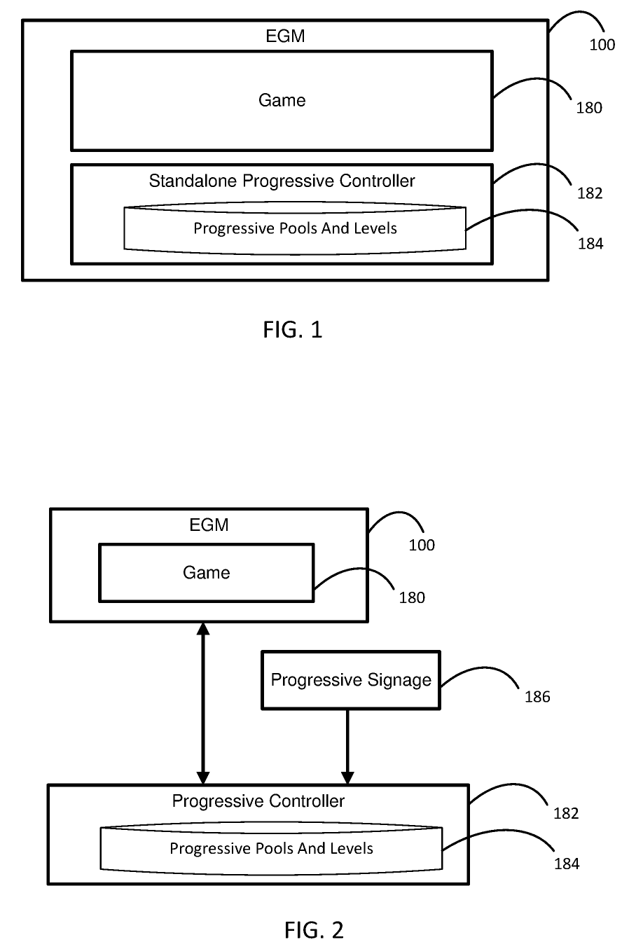

Some slot games may typically participate in symbol driven progressives or mystery progressives. Symbol driven progressive awards may be typically incorporated into the math of the base game’s paytable and winning levels (paylines, etc) are associated with one or more progressive levels of a progressive prize pool maintained by one or more progressive controllers. When one or more of these paylines are hit by a player during a spin of the game, and if a qualifying wager was made, then the player may win one or more of the associated progressive levels. The progressive levels of a progressive prize pool managed by a progressive controller generally accrue as a function of wagers made by players on one or more connected electronic gaming machines (EGMs) playing one or more configured games, paytables and denominations on those EGMs. These associated progressive award levels may be managed by the EGM itself, an associated controller device (e.g., progressive controller, etc.), or managed by a separate system, such as is typically used with a Wide Area Progressive (WAP). Wide Area Progressives may link one or more EGMs across multiple casino sites and/or casino operators to offer players larger, life changing jackpots. For example, brief reference is now made to FIG. 1, which is a schematic block diagram illustrating a standalone progressive jackpot with one or more progressive pools and/or levels maintained by the EGM or game software itself according to some embodiments. As illustrated, embodiments may include an EGM 100 that is operable to provide a game 180 that includes a progressive jackpot game 180. In some embodiments, a stand-alone progressive controller 182 may maintain and/or manage the progressive jackpot game 180 including progressive pools and levels 184 of the progressive jackpot game 180.

Brief reference is now made to FIG. 2, which is a schematic block diagram illustrating a progressive controller maintained and/or managed progressive jackpot with one or more progressive pools and/or levels maintained by the EGM or game software itself according to some embodiments. As illustrated, embodiments may include an EGM 100 that is operable to provide a progressive jackpot game 180. A progressive controller 182 may maintain and/or manage the progressive jackpot game 180 including progressive pools and/or levels 184.

Embodiments may include a symbol driven progressive jackpot game 180 managed by a progressive controller 182 connected to one or more EGMs 100 within a casino site. This progressive controller 182 can be separate from an existing casino system or be a component of the existing casino system.

The functions of the progressive controller 182 may also be performed by an EGM 100. For example, in a bank of eight EGMs 100, one of the EGMs 100 can perform the role of the progressive controller 182. In some embodiments, this configuration may be used when progressive signage 186 is not necessary and there may be an opportunity to avoid the cost of the progressive controller 182.

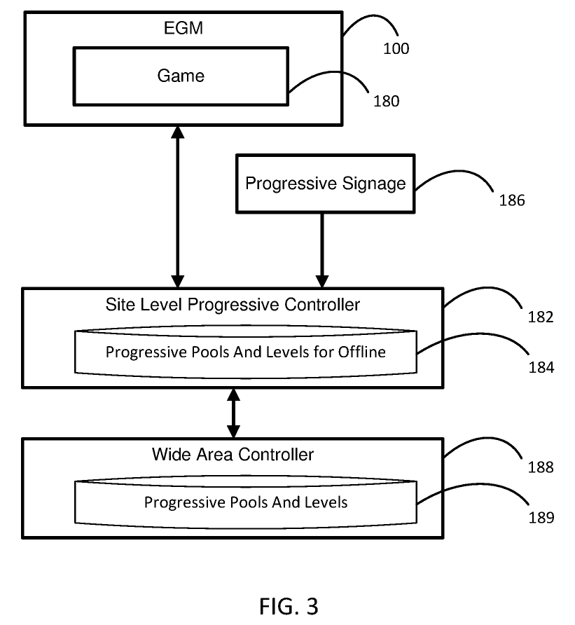

Reference is now made to FIG. 3, which is a schematic block diagram illustrating a progressive controller maintained and/or managed progressive jackpot with one or more EGMs across multiple casino sites according to some embodiments. As illustrated, embodiments may include an EGM 100 hat is operable to provide a progressive jackpot game 180. A progressive controller 182 may maintain and/or manage the progressive jackpot game 180 including progressive pools and/or levels 184 corresponding to periods in which the site level progressive controller 182 is off-line.

Embodiments may include a symbol driven progressive jackpot game 180 managed by a site level progressive controller 182 that may be directly and/or indirectly connected to a wide-area controller 188 and/or one or more EGMs 100 at different casino sites. The wide area controller 188 may maintain and/or manage progressive pools and/or levels 189 corresponding to multiple casino sites.

In some embodiments, all of the casino sites can be associated with the same operator while other embodiments provide that the casino sites may be associated with multiple different casino operators.

Some embodiments provide that mystery progressives can also be associated with one or more games on one or more EGMs 100. Mystery progressives may not typically be associated with changes in the game math of the underlying game. As a result, the award trigger may not be associated with one or more wins determined by the game’s paytable (paylines, etc). Instead, mystery progressive awards may be determined by a mystery progressive controller. Some embodiments provide that determining when a mystery progressive award is hit may include a magic number approach in which the controller is configured with a progressive level value range that the mystery must hit within and a Random Number Generator (RNG) determines a value within that range where a winner is chosen when the level hits that value. In some embodiments, the magic number may be determined when the mystery progressive controller initializes the level, such as, for example, on initial setup or after a hit.

In some embodiments, the mystery progressive may include a magic time approach in which the controller is configured with a time range that the mystery must hit within (ex: in the next week). A RNG may be used by the mystery progressive controller to determine a time within that range where the mystery progressive level will hit. In some embodiments, the magic time may be determined when the controller initializes the level, such as, for example, on initial setup or after a hit.

Mystery progressives can be run by an EGM, a controller for a bank or site, and/or one or more controllers that coordinate mystery progressive levels across EGMs at one or more sites, including across multiple casino operators.

In some embodiments, one or more progressive levels maintained by a progressive controller can be denominated in a currency other than the base currency of the casino site. Some embodiments provide that each level can be configured with a particular currency type in a progressive configuration. For example, in a single progressive level configuration, the top award can be denominated a first cryptocurrency (e.g., Bitcoin, among others). In multi-level configurations, the currency configured for each level may vary based upon the particulars of the game (in the case of symbol driven progressives) or the configuration of the progressive controller.

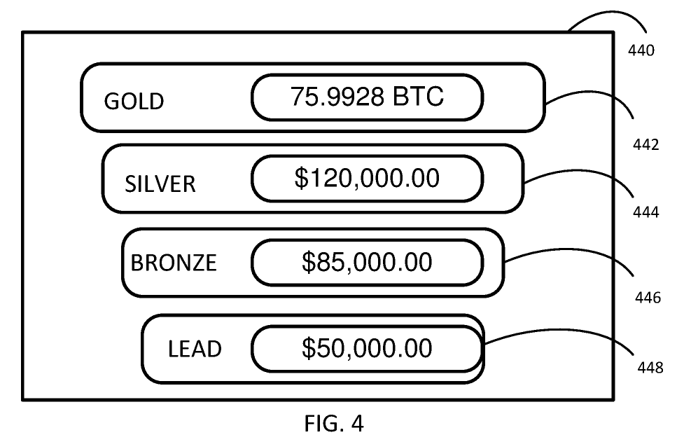

Brief reference is now made to FIG. 4, which is a schematic view of a screenshot including payout opportunities corresponding to a progressive jackpot game according to some embodiments disclosed herein. The screenshot 440 includes different levels of progressive award values. As illustrated, the top progressive award value is a GOLD level award 442 and is denominated in a currency other than the base currency corresponding to the location of the EGM. For example, the top progressive award value 442 may be denominated in a cryptocurrency such as Bitcoin, among others. The remaining progressive award values include a SILVER level award value 444, a BRONZE level award value 446 and a LEAD level award value 448, all of which may be denominated in a base currency of the location of the EGM. For example, award values 444, 446 and 448 may all be denominated in US Dollars, among others.

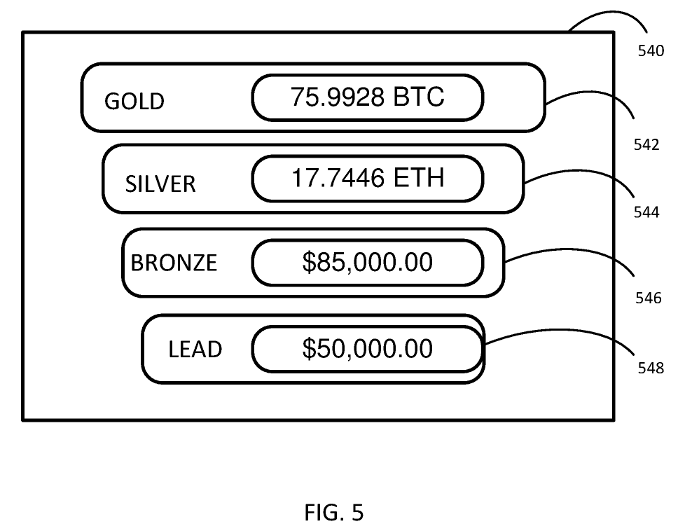

In some embodiments, different cryptocurrency types may be described and/or associated with a given progressive prize pool. For example, brief reference is now made to FIG. 5, which is a schematic view of a screenshot including payout opportunities corresponding to a progressive jackpot game according to some embodiments disclosed herein. As illustrated, the GOLD level award value 542 in the diagram may be in a first cryptocurrency such as Bitcoin and the SILVER level award value 544 may be in a different cryptocurrency, such as, for example, Ethereum, among others. Other of the level award values may be denominated in another currency such as a base currency of the location of the EGM.

Denominating levels in a progressive prize pool in one or more cryptocurrencies may present challenges based on the volatility of each cryptocurrency. In some embodiments, the progressive contributions for each prize pool in the local currency of the EGM can be converted to the appropriate cryptocurrency value based upon the current market conversion rate and this converted amount can be displayed to the player in some fashion (on the EGM, on attached signage, etc.) In some embodiments, the progressive controller can perform this conversion operation when configured with the current conversion ratio, such as from communications with a central component that may provide the latest conversion ratio (ex: financial data feed, etc.) In some embodiments, the local currency value of each progressive level can be provided by the progressive controller to the EGM and/or display such as signage. In some embodiments, the conversion ratios and endpoints such as an EGM and/or signage may perform the conversions. The player who has hit one or more jackpot levels can then be paid their winning jackpot value in the associated cryptocurrency according to embodiments discussed herein. In either conversion model, the volatility of the underlying cryptocurrency may make the jackpot less appealing to players if the conversion to cryptocurrency only happens after a jackpot hit occurs. As a result, any appreciation of the underlying cryptocurrency between the time the jackpot is reset and when the next hit of a jackpot level occurs may not provide advantages to players. In other words, volatility of the underlying cryptocurrency may not add to the overall player excitement associated with winning the jackpot value.

Some embodiments provide that to a lack of participation in the volatility of the underlying cryptocurrency associated with each progressive level, the conversion of progressive prize level contributions from the local currency to the cryptocurrency associated with a jackpot level occurs on a periodic basis. In some embodiments, converting cash, and/or local currency, into cryptocurrency generally requires use of a cryptocurrency exchange (Coinbase, Binance, Kraken, etc.), and conversion from cash to cryptocurrency may be associated with conversion and purchase fees (1.5% - 0.25%). Many cryptocurrency exchanges also have a base fee (ex: $2.99) as well, which may make a series of small conversions un-economical. Some embodiments provide that these conversion and/or purchase fees may scale based on the amount associated with the transaction. In an effort to minimize the fees paid for conversion to cryptocurrency, some embodiments provide that a progressive prize pool may maintain zero or more additional cryptocurrency escrow levels and/or pool values to hold contributions corresponding to wagers from EGMs in the local currency, and these cash prize pool escrow levels may be reset to 0 once a conversion from the base currency of the EGM to the appropriate cryptocurrency used for each particular level has occurred. In some embodiments, the conversion may be performed on a given time interval, a threshold value and/or a combination thereof.

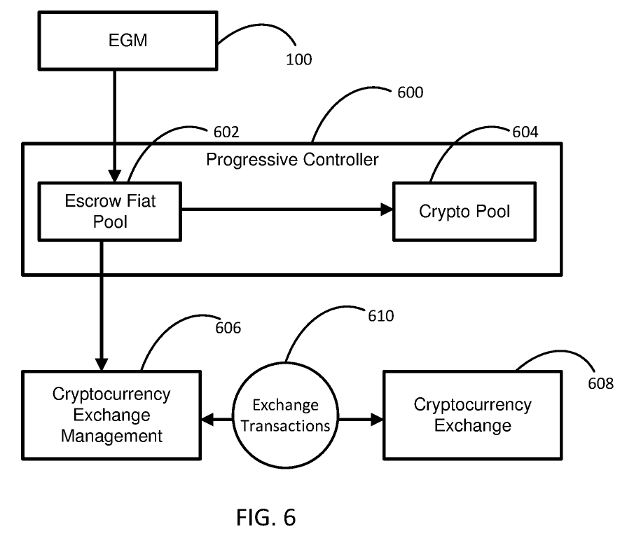

In some embodiments, a single level jackpot may maintain two or more prize pools. For example, a main cryptocurrency prize pool (in, e.g., BTC) and a cryptocurrency conversion escrow pool (in, e.g., USD) may be maintained. Reference is made to FIG. 6, which is a schematic block diagram of a cryptocurrency progressive game according to some embodiments disclosed herein. As illustrated, the EGM 100 may provide data corresponding to contributions from wager portions that may be provided to fund the progressive jackpot to the progressive controller 600. In some embodiments, the EGM 100 may just provide wager information, and the progressive controller 600 may know the percentage of wagers to contribute to the progressive pool. Some embodiments provide the EGM does not know the progressive contribution rate.

In some embodiments, the progressive controller includes an escrow fiat pool 602 of non-crypto currency portions and a crypto pool 604 that holds award portions that are denominated in cryptocurrency. In some embodiments, as the escrow fiat pool 602 increases by a given amount and/or over a given time interval, the cryptocurrency exchange management component 606 may exchange transactions 610 with a cryptocurrency exchange 608 to provide cryptocurrency denominated funds to the crypto pool 604.

Some embodiments provide that the various components described herein may be combined, operated onsite at a single casino site, and/or be spread across different locations. For example, the cryptocurrency exchange management component 606 may run centrally at the location of the EGM manufacturer or game manufacturer, whereas the progressive controller 600 may run onsite at a single casino, or centrally, etc.

While the conversion to cryptocurrency may occur on a timed interval (ex: 24 hours), jackpot hits may occur while fiat funds are in the escrow pool (or escrow levels). Upon a jackpot hit, the progressive controller may immediately notify the components involved in converting fiat to cryptocurrency to exchange the remaining amount into cryptocurrency. In another embodiment, the player may not be paid at all from the funds in the escrow fiat pool.

The disclosure and content of U.S. Patent Application No. 17/410,954, filed Aug. 24, 2021, entitled, “CRYPTOCURRENCY DENOMINATED PROGRESSIVE AWARD, are incorporated herein, the disclosure and content of which is incorporated herein in its entirety.

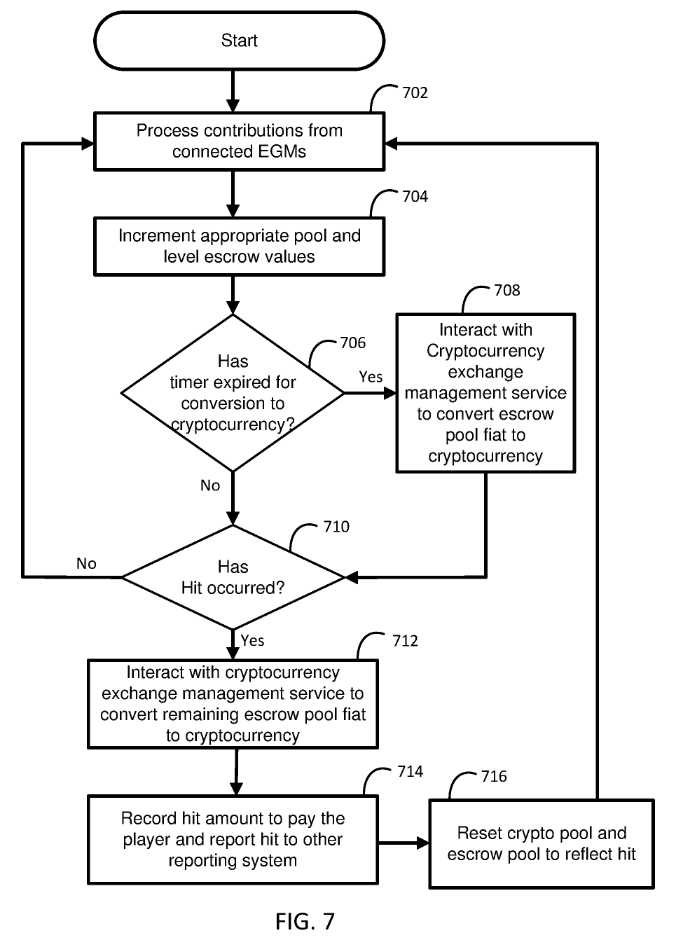

In some embodiments, the player may be paid the amount of fiat held in the escrow fiat pool. For example, reference is made to FIG. 7, which is a schematic block diagram illustrating cryptocurrency progressive management according to some embodiments disclosed herein. At block 702, contributions from connected EGMs are processed. Appropriate pool and escrow values are incremented (block 704). At block 706, the progressive controller determines if the timer has expired for conversion to cryptocurrency. Some embodiments provide that an explicit amount of escrow may trigger a conversion to cryptocurrency. If the timer has expired, then the progressive controller may interact with a cryptocurrency exchange management service to convert the escrow pool fiat to cryptocurrency (block 708.) If the timer has not expired, then the progressive controller determines if a hit has occurred (block 710). As used herein, a hit refers to any event that results in a payout of the progressive award.

Once the progressive controller has interacted with the cryptocurrency exchange management service to convert escrow pool fiat to cryptocurrency, then the progressive controller determines if a hit has occurred (block 710). If a hit has not occurred, then the progressive controller processes contributions from connected EGMS (block 702).

If a hit has occurred, then the progressive controller interacts with the cryptocurrency exchange management service to convert remaining escrow pool fiat to cryptocurrency (block 712). The award amount to pay the player is recorded and the hit is reported to another reporting system (block 714). The crypto pool and the escrow pool may be reset (block 716) and the process may continue to process contributions from connected EGMs (block 702).

One effect of the above operation including delayed conversions between fiat and cryptocurrency may be that the progressive prize pool levels associated with a given cryptocurrency will only move (or progress) when the conversion occurs. Players may be generally used to seeing progressive prize pool levels progressing in a smooth way. The lack of progression in the crypto prize pool levels may be concerning to players such that they may not want to play games with progressive prize pool levels that are denominated in cryptocurrency.

In some embodiments, this issue may be addressed by converting the amount held in the one or more fiat escrow prize pools to cryptocurrency using the current market conversion rate and adjusting the display of the progressive prize pool levels denominated in a cryptocurrency. For example, the cryptocurrency value displayed may be a combination of the actual cryptocurrency held by the pool plus a representation of how much cryptocurrency would be obtained if the amount held in the escrow pool was immediately converted to the appropriate cryptocurrency. In some embodiments, the rate of change of the cryptocurrency prize pool levels can be estimated and/or configured to a certain accrual rate. In this manner, the value displayed in cryptocurrency can reflect the expected growth in cryptocurrency value based upon historic conversions of fiat in the escrow pool to the cryptocurrency level value. The amount in the cryptocurrency pool level(s) may then be reset or adjusted when the amount held in the escrow pool is converted when the next conversion period occurs. In some embodiments, the cryptocurrency prize pool values can be adjusted based upon the historic or configured expected rate of change of the escrow pool and that value can be converted to the appropriate cryptocurrency value based upon the current market value of the associated cryptocurrency. In some embodiments, the progressive signage associated with a game with one or more progressive levels denominated in cryptocurrency can display both the cryptocurrency value that has been converted and the amount held within the escrow pool for that progressive level, as illustrated in the below diagram.

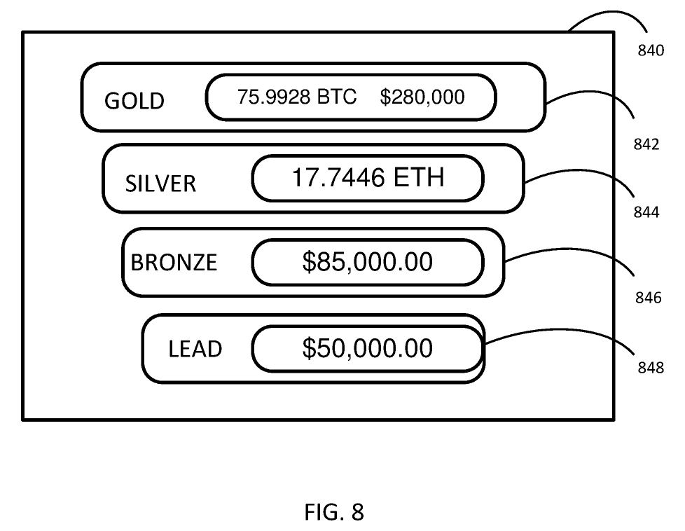

For example, brief reference is now made to FIG. 8, which is a schematic view of a screenshot including payout opportunities corresponding to a progressive jackpot game according to some embodiments disclosed herein. As illustrated, the GOLD level award value 842 in the diagram may be in a first cryptocurrency such as Bitcoin and a corresponding cash value. The SILVER level award value 844 may be in a different cryptocurrency, such as, for example, Ethereum, among others. Other of the level award values 846, 948 may be denominated in another currency such as a base currency of the location of the EGM. This allows players to see the growth in the escrow pool and see the conversion between values in the escrow pool for that level and the conversion to cryptocurrency for that level. In some embodiments, the escrow pool may increase in value at a configured rate, or based upon a historical rate, and then periodically re-sync’d with the actual value of the actual escrow pool value to maintain an incrementing appearance.

Other embodiments for converting the escrow pool fiat to cryptocurrency are also contemplated herein. Players interested in cryptocurrency, such as Bitcoin, are likely interested because the value of the Bitcoin is increasing. These players are also likely interested, or believe, that Bitcoin will continue to increase in value. The system can leverage this to provide the player or system additional value.

In some embodiments the fiat to cryptocurrency happens in response to a change in the cryptocurrency value. For example, the system may convert when there is a dip in the Bitcoin value such as a 10% decline in the cryptocurrency value (compared to dollars). The screen, system, SMIB, signage and/or player mobile device might display this such as “Bitcoin just went down so $5,256 was converted to 0.1 BTC”. This may be seen as a positive event to somebody who believes Bitcoin will increase in value over time.

In some embodiments, the fiat to cryptocurrency happens in response to a rate of play of the games participating in the cryptocurrency progressive pool. Such rates may include the number of players, number of games played, and/or amount of money wagered on the games, among others. When there is more interest, more conversion can happen to drive even more interest because the EGM, system or player mobile device notifies players when the conversion happens. These may be positive events to anyone interest in cryptocurrencies.

Other game or system events could trigger the conversion such as winning a particular game award, bonus game, bonus trigger, system trigger, and/or a system event, among others. For example, a game could hit a payline that corresponds to performing a bitcoin conversion.

In some embodiments the conversions could be triggered based on complex market indicators such as the 50-day moving average or relative strength index (RSI). In one example, a casino might set such triggers to convert the fiat pool to crypto when the indicators show “oversold” or “undervalued”.

In some embodiments, the casino might stop converting the fiat progressive values to crypto because the market indicators for the cryptocurrency indicate a negative market, “overbought” or “overvalued”. In some embodiments, the casino could sell the crypto currency pool and convert back to fiat similar to a stock “Stop” or “Stop Limit” order which sells an asset when it falls below a threshold.

In some embodiments, an EGM, service window, SMIB, player mobile device and/or signage can indicate the current progressive values including the fiat pools. The signage and/or other display devices can indicate when conversion from fiat to cryptocurrency happens and celebrate the conversion as a positive event. For example, a fireworks explosion could be shown (with audio) when the conversion happens. The signage can also show the current fiat to cryptocurrency conversion rate(s). The signage can indicate when a conversion is likely to happen next, such as in about 2 minutes, if Bitcoin changes in value a little more, or when the next game/system event triggers the conversion.

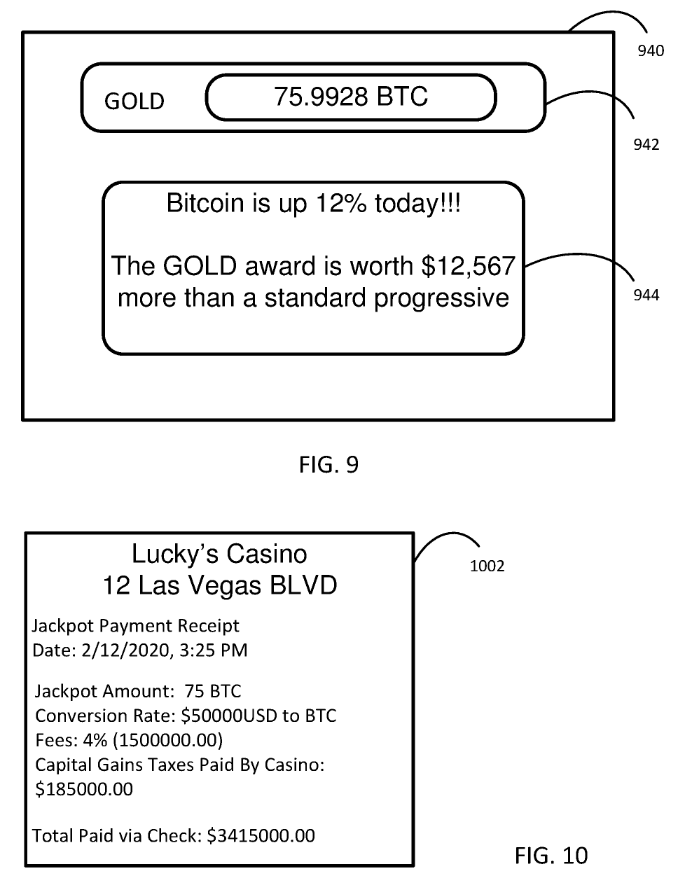

In some embodiments, the signage could show what the progressive value would have been if it were not for the cryptocurrency conversion feature that is proposed in this invention. For example, the system may have been in operation for 2 weeks with fiat to cryptocurrency happening every 4 hours. The system might show the current progressive award as “3.0 BTC or $150,000USD” and may also show that without the cryptocurrency conversions the current progressive award would have only been “$98,000”. For example, brief reference is now made to FIG. 9, which is a schematic view of a screenshot 940 including payout opportunities corresponding to a progressive jackpot game according to some embodiments disclosed herein. As illustrated, the GOLD level award value 942 is displayed as a Bitcoin value. The screenshot may also include a performance portion 944 that displays the relative value of the cryptocurrency progressive relative to the standard fiat currency. This shows the player the benefit of the of the cryptocurrency progressive over other products offered in the casino space.

Responsive to a player wining a jackpot denominated in cryptocurrency, the player may be paid in the cryptocurrency that they have won. In the case of a traditional progressive jackpot, the casino and/or progressive system operator may be provided with a written check, a bank transfer and/or other form of legal tender. In the case of a player winning a cryptocurrency based progressive award, a variety of options may be used. For example, in some embodiments, a player may be paid by converting the cryptocurrency to cash and paying the remaining amount (after fees) using the traditional payment mechanisms. Some embodiments provide that the player may be paid by transferring the cryptocurrency to the player’s chosen external crypto wallet using a transfer on a blockchain. Some embodiments include transferring the cryptocurrency to a crypto wallet of the player’s casino resort wallet.

Embodiments herein may include requisite gaming device and jackpot verification procedures as required by the gaming jurisdiction and/or internal controls of the casino and that may have occurred prior initiating a process of paying the player.

In some embodiments, the player may be paid in fiat currency using the current cryptocurrency to fiat conversion rate minus applicable fees. The amount remaining may be paid to the player directly (in cash), by check, or by electronic transfer to the player’s bank account (ACH, etc). This type of conversion may offer the casino and/or wide area progressive system operator to impose additional fees beyond what they may have to pay for the cryptocurrency to fiat conversion. In some embodiments, the operator and/or wide area progressive system operator may pay any capital gains taxes that have occurred during the period when the cryptocurrency was originally purchased and the time when it was sold. Some embodiments provide that the exchange cryptocurrency management system can track the original purchase price and the sale price associated with each segment of cryptocurrency and may provide reporting to the casino operator so that the proper amount of taxes can be withheld from the payment to the player and for accounting purposes. Brief reference is made to FIG. 10, which is a depiction of an example receipt for the jackpot payment of a cryptocurrency win when paid in fiat currency according to some embodiments disclosed herein. As illustrated, the receipt 1002 may include data corresponding to the date, time, jackpot amount, conversion rate, fees, capital gains taxes paid by the casino and/or the total paid by check to the player, among others.

The above example is non-limiting and thus not exhaustive. In some embodiments, the player’s jackpot amount could be a combination of the cryptocurrency amount held in the pool plus the fiat value remaining in the escrow pool for the winning levels the player hit.

In some embodiments, the winning amount can be converted to fiat and deposited into the player’s cashless wagering account (Resort Wallet, etc.)

In some embodiments, the amount paid to the player in cash may be a subset (ex: 50%) of the amount won when they take the amount in cash. Such embodiments may be applicable to jackpots won for wide area progressive wins in which the player is given an option to get a 50% cash payout today or get paid using an annuity over 30 years.

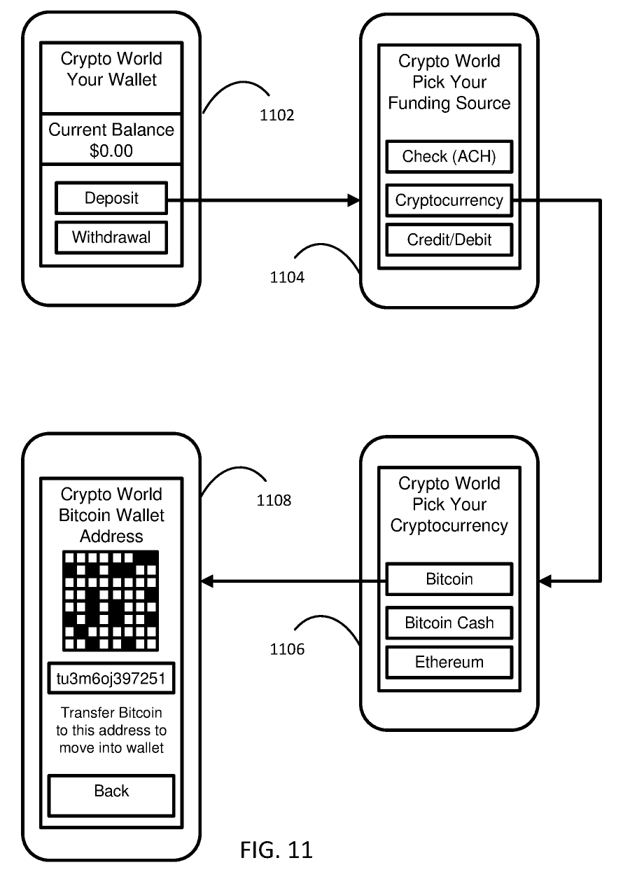

In some embodiments in which the payment is transferred to the player’s external crypto wallet, the player can transfer their winning cryptocurrency amount to their external cryptocurrency wallet. This may include the player sharing information about their external cryptocurrency wallet with the casino via some mechanism (e.g., a QR code), etc. The casino may also be required to collect certain Know Your Customer (KYC) information from the player to perform the transfer, including, but not limited to name (first, last, etc.), birthdate, last four digits of Social Security Number (SSN), primary residence, and/or the purpose of the external cryptocurrency account, among others. Reference is now made to FIG. 11, which is a schematic flow diagram that illustrates an example of a player presenting their blockchain address QR code, to be scanned by the casino and/or wide area progressive operator personnel, to initiate the transfer according to some embodiments. A mobile device graphical user interface 1102 may be used to select whether to deposit or withdraw from the cryptocurrency wallet. A funding source may be selected 1104 to determine what the source is from among a check, cryptocurrency and credit/debit sources. Since this example illustrates the selection of cryptocurrency, the selection of which cryptocurrency is made 1106. A bitcoin wallet address is provided 1108 to transfer the bitcoin to the bitcoin wallet. In some embodiments, the bitcoin wallet may be presented in the form of data that may be visually scanned and/or an address expressed as an alpha-numeric string that may be typed into a terminal.

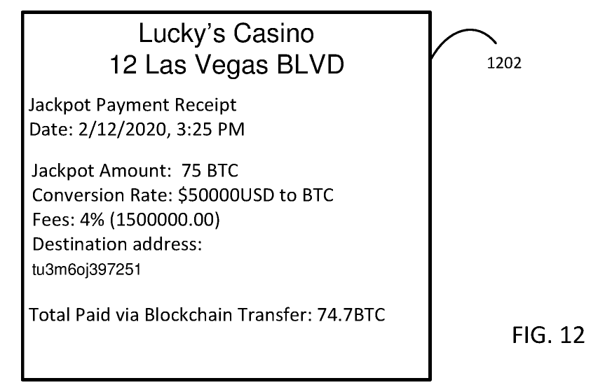

The component of the progressive system involved in the transfer, which may be a cryptocurrency exchange management service, may interact with the appropriate cryptocurrency exchange and/or blockchain directly to trigger the transfer. In some embodiments, the cryptocurrency exchange management service may require approvals from one or more administrative users to perform the transfer. Some embodiments provide that the cryptocurrency exchange management service may also maintain a log of the transaction and other historical transactions for auditing purposes. In some embodiments, the cryptocurrency exchange management service or a component of the progressive system may also print the player a receipt containing information about their transfer. For example, brief reference is made to FIG. 12, which is a depiction of an example jackpot payment receipt for a cryptocurrency payment transfer receipt according to some embodiments disclosed herein. As illustrated, the receipt 1202 may include data corresponding to the date, time, jackpot amount, conversion rate, fees, destination address, and/or the total paid by blockchain transfer, among others.

While the above example shows a physical receipt, other forms of receipts can also be used. For example, a receipt can be emailed to the player, and/or texted to the player, etc. Some embodiments provide that other information can be displayed on the receipt as the above is not exhaustive. For example, the source blockchain address may be printed, the player’s name, and/or other personally identifying information may also be printed.

The casino or wide area progressive system operator may also maintain accounts with various cryptocurrency held on various cryptocurrency exchanges so that transfers to players can have lower fees. Typically, “within the exchange” cryptocurrency transfers may not require the payment of any blockchain transfer fees and the cryptocurrency exchange management service may offer the employee who is triggering this transfer the ability to select the source cryptocurrency exchange in order to reduce transfer fees paid by the player and/or to increase the overall profit of the casino or manufacturer running the wide area progressive system.

Embodiments in which the transfer is to the crypto wallet of the player’s casino resort wallet may be more suitable for smaller jackpot values. For example, some embodiments include transferring the cryptocurrency the player has won from a jackpot to their cashless wagering account. If the cashless wagering account, or resort wallet, supports holding cryptocurrency in addition to other credit types (cash, etc.), then the player’s wallet can hold the amount of cryptocurrency won. This may allow the player to later convert some or all of that cryptocurrency to cash, or gain access to a line of credit equal to or less than the cash value of the cryptocurrency held in their account. The player can then also transfer their cryptocurrency funds held in their resort wallet to their external wallet on at their own leisure.

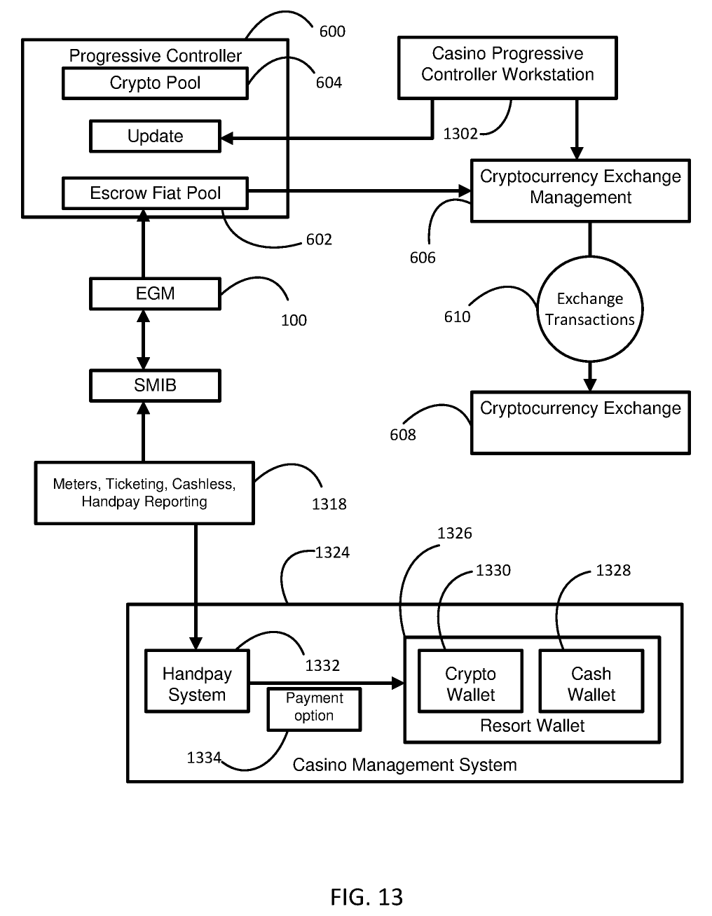

Reference is now made to FIG. 13, which is a flow diagram illustrating operations and components for a progressive jackpot award deposit into a player’s resort wallet according to some embodiments. As illustrated, the payment to the player’s resort wallet 1326 can be sent from the progressive controller 600 (or a component thereof or related to the progressive controller 600, such as the cryptocurrency exchange management system 606), or from the handpay system 1332 of the operator’s casino management system 1324. The exact component triggering the transfer may vary based upon who is running the progressive controller 600. For example, if the progressive jackpot is a small standalone progressive, then it may be likely that the payment will be triggered manually by the operator via a casino progressive controller workstation 1302, or through an integration with the handpay system 1332 of the operator’s casino management system 1324. If the progressive is a larger jackpot, then it may be paid by a component of the progressive controller 600 (or a related component) or paid directly by the operator 1302 of the progressive controller 600. Certain features of this figure are discussed in other embodiments, which will not be discussed again to avoid redundancy.

Some embodiments provide that jackpot payment may include a crypto annuity portion. In some embodiments, larger jackpot values may be awarded in either a large lump sum payment or an annuity in which payments are provided over time. Such examples may include situations in which the jackpot is a large wide area progressive jackpot. In some embodiments, the cryptocurrency won by a player can be transferred to an on-blockchain smart contract. A progressive jackpot smart contract can be initialized by a jackpot payment of cryptocurrency by a casino operator and/or wide area progressive system operator when a given player wins one or more progressive jackpots. This player’s winning cryptocurrency may then be transferred to the smart contract 1408 for management by the smart contract. The smart contract may then pay out a percentage of the player’s jackpot winnings on a configured basis, or as defined in a message sent to the smart contract during initialization. For example, the smart contract may have a period of 30 years and pay out 1/30^{th} of the player’s cryptocurrency winnings every year (ex: Jan 1^{st}), to the player’s configured external blockchain wallet (also as set during initialization). Some embodiments provide that the smart contract can be configured to pay out management and/or processing or other fees to other parties. For example, in the case of a wide area progressive jackpot, the operator of the wide area progressive jackpot system may collect 25% of the total amount of cryptocurrency available to be paid out for this period (25% * 1/30^{th} of the winning amount). Other parties can also participate in the fee structure, such as the casino operator.

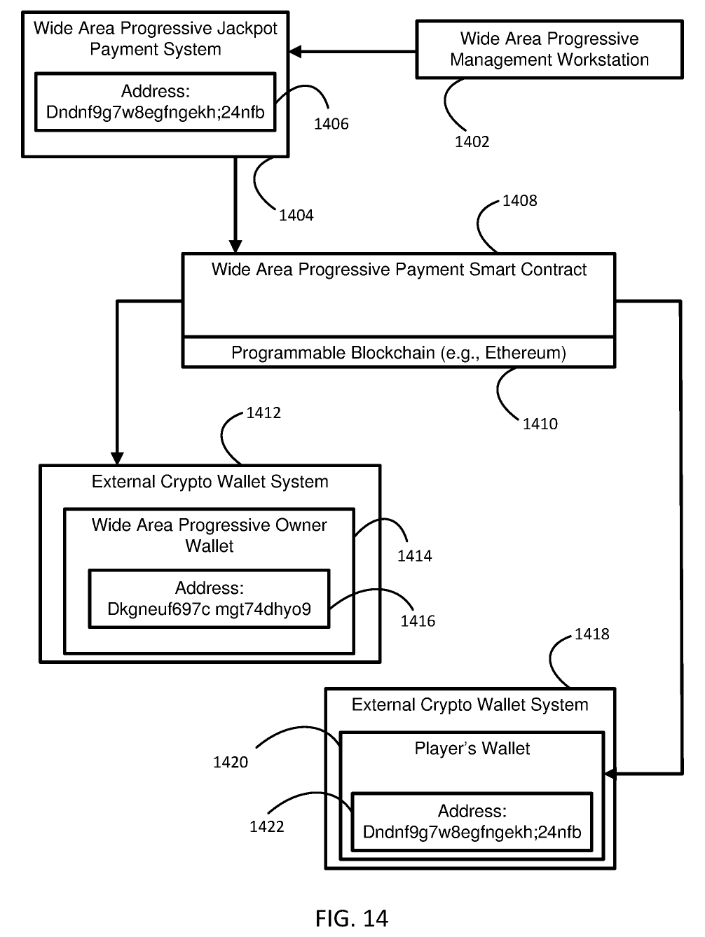

Reference is now made to FIG. 14, which is a flow diagram illustrating operations and components for a progressive jackpot award annuity smart contract payment according to some embodiments. A wide area progressive management workstation 1402 may cause data to be sent to a wide area progressive jackpot payment system 1404 that includes a given cryptocurrency address 1406. In some embodiments, the cryptocurrency address 1406 is obtained from the player using one or more of methods as disclosed herein. The wide area progressive jackpot payment system 1404 sends the jackpot payment, party and/or account data corresponding to the jackpot payout to a wide area progressive payment smart contract 1408.

The wide area progressive payment smart contract 1408 communicates with an external crypto wallet system 1412 that includes a wide area progressive owner wallet 1414 and a corresponding address 1416 and also with an external crypto wallet system 1418 that includes a player’s wallet and a corresponding address 1422. In this manner, the progressive cryptocurrency jackpot may be paid using the wide area progressive payment smart contract 1408 as an annuity.

In some embodiments, wide area progressive jackpots may be paid out using annuities purchased from insurance companies. For example, if the player wins a $40m jackpot, the player has the option of getting paid 50% of the total amount immediately or getting paid the $40m jackpot over 30 years using the annuity. This allows the company that runs the wide area progressive jackpot to recognize an immediate 50% profit when the player is paid. In some embodiments, the cryptocurrency jackpot winnings act like a bond with a 1/30^{th} annual coupon, and the value of the coupon could appreciate each year at the rate that the underlying cryptocurrency appreciates at relative to fiat.

Some embodiments provide methods for awarding cryptocurrency progressive jackpots to uncarded players and/or awarding fiat instead of a cryptocurrency. An uncarded player is a player without a player account and/or who is not playing using a player account, mobile app and/or who has not otherwise logged into a player loyalty system for identification.

In some embodiments, uncarded players and/or players without player accounts may win the fiat currency without the cryptocurrency pool conversions. For example, the system is running for 2 weeks and the top award is 6.0 BTC or $300,000. Over the past 2 weeks many fiat to cryptocurrency conversions have happened totaling $200,000. BTC has increased over the past 2 weeks so the prize pool is $300,000 worth of dollars instead of $200,000. Uncarded players would be awarded the $200,000, while carded players would win the 6.0BTC which is worth $300,000. In some embodiments, the player must have a certain player loyalty account status level to qualify for the cryptocurrency award such as a gold player loyalty level.

In some embodiments, the fiat award may also be given to players instead of the crypto award based on other parameters. In some embodiments, only players wagering a certain amount of money or playing a certain denomination may win the crypto award. For example, the fiat contribution might be $200,000 and the current progressive award might be $300,000. Only players wagering a maximum bet can win the crypto award of $300,000 while players at other denominations win the $200,000. Similarly, the awarding may be based on wager, denomination, triggering a game feature, playing a certain game theme, playing a certain game paytable, achieving a certain game feature, hitting a certain bonus, winning a certain game pay (such as 3 cherries), a random event of the game, a random event of the casino or system, and/or change in the crypto currency exchange rate. In some embodiments, in response to a change in the crypto currency exchange rate, the casino may choose to award the fiat because the cryptocurrency has fallen in value to an amount below the fiat conversion value.

In some embodiments, a player who does not wager a minimum required amount may be awarded a secondary prize instead of the progressive level denominated in cryptocurrency, such as the escrow value for that level.

As an example of denomination being the eligibility trigger for the crypto award, some players play on player selectable multi-denomination (PSMD) games. PSMD games may allow multiple denominations of a game to link the same progressive award level. The games can do this by changing the odds for the game level linked to the progressive based on the denomination. For example, a game play at 1-cent, 5-cent or 25-cent could all contribute to, and win, the same $50,000 progressive prize with the 25 cents denomination being 5 times as likely to hit the award than the 5-cent denom. In this example, embodiments herein would allow a casino to award the crypto currency for a hit on the 25-cent play, but the fiat prize for the 1-cent and 5-cent plays. In some embodiments, the player may only be awarded a secondary prize, such as the fiat currency held in the escrow pool for the level that they have won.

In some embodiments, some denominations will contribute to a fiat pool, while other denominations of the same game contribute to the crypto pool.

While embodiments herein are described for cryptocurrencies, the embodiments may be applied to any asset that fluctuates such as stocks, options, futures, bonds, real estate, commodities, or currency exchanges.

Embodiments herein may work for casino games, video lottery terminal games, social casino games, mobile casino games and sports wagering terminals that offer progressive or mystery awards.

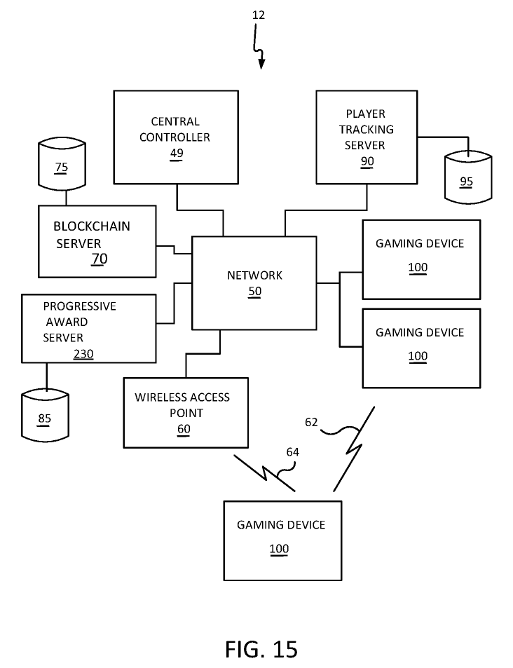

Reference is now made to FIG. 15, which illustrates a casino management system 12 including a plurality of gaming devices 100 according to some embodiments herein. The casino management system 12 may be located, for example, on the premises of a gaming establishment, such as a casino, in a private residence, or may include components that are located at different locations. The gaming devices 100 may be in communication with each other and/or a central controller 49 through a data communication network 50, or remote communication link. The data communication network 50 may be a private data communication network that is operated, for example, by the gaming facility that operates the gaming device 100, a publicly accessible data communication network such as the Internet, or a combination thereof. Communications over the data communication network 50 may be encrypted for security. The central controller 49 may be any suitable server or computing device which includes at least one processor circuit, such as a processor, and at least one memory or storage device. Each gaming device 100 may include a processor circuit that transmits and receives events, messages, commands or any other suitable data or signal between the gaming device 100 and the central controller 49 and/or other gaming devices 100. The gaming device processor is operable to execute such communicated events, messages or commands in conjunction with the operation of the gaming device 100. Moreover, the processor of the central controller 49 is configured to transmit and receive events, messages, commands or any other suitable data or signal between the central controller 49 and each of the individual gaming devices 100. In some embodiments, one or more of the functions of the central controller 49 may be performed by one or more gaming device processors. Moreover, in some embodiments, one or more of the functions of one or more gaming device processors as disclosed herein may be performed by the central controller 49.

A wireless access point 60 provides wireless access to the data communication network 50. The wireless access point 60 may be connected to the data communication network 50 as illustrated in FIG. 15 or may be connected directly to the central controller 49 or another server connected to the data communication network 50.

One or more servers, such as a player credit server 80, may also be connected through the data communication network 50. Similarly, the gaming content server 80 may manage delivery of the gaming content to the user of a gaming device 100. The gaming content may be stored in a gaming content database 85. A blockchain server 70 may manage access, update, storage, consensus determination, and/or cryptocurrency denominated progressive status. The blockchain data may be stored in a blockchain database 75. The blockchain server 70 and a player credit server 80 may be implemented within or separately from each other. The blockchain server 70 and a progressive award server 230 may also be implemented within or separately from the central controller 49.

A player tracking server 90 may also be connected through the data communication network 50. The player tracking server 90 may manage a player tracking account that tracks the gameplay and spending and/or other player preferences and customizations of a player, i.e., the user of the gaming device 100, manages loyalty awards for the player, manages funds deposited or advanced on behalf of the player, and other functions. Player information managed by the player tracking server 90 may be stored in a player information database 95. In some embodiments, the player information database 95 and/or the player tracking server 90 may include and/or provide information that may be used by the blockchain server 70 to detect excluded players. For example, data corresponding to an excluded player may be received responsive to the excluded player submitting and/or inserting a player tracking card to a gaming table or machine.

The gaming devices 100 communicate with one or more elements of the system 12 to coordinate providing streaming video content and synchronized gaming content. For example, in some embodiments, a gaming device 100 may communicate directly with another gaming device 100 over a wireless interface 62, which may be a WiFi link, a Bluetooth link, an NFC link, etc. In other embodiments, the gaming device 100 may communicate with the data communication network 50 (and devices connected thereto, including EGMs) over a wireless interface 64 with the wireless access point 60. The wireless interface 64 may include a WiFi link, a Bluetooth link, an NFC link, etc. In still further embodiments, the gaming device 100 may communicate with other gaming devices 100 or other devices over the wireless interface 62 and the wireless access point 60 over the wireless interface 64. In these embodiments, the wireless interface 62 and the wireless interface 64 may use different communication protocols and/or different communication resources, such as different frequencies, time slots, spreading codes, etc. For example, in some embodiments, the wireless interface 62 may be a Bluetooth link, while the wireless interface 64 may be a WiFi link.

The wireless interfaces 62, 64 allow the gaming devices 100 and/or central controller 49 to coordinate providing player data from gaming devices 100.

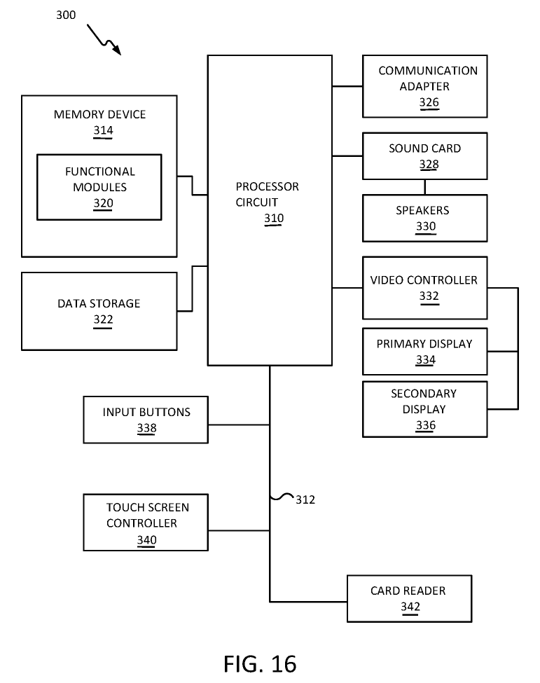

Reference is now to FIG. 16, which is a block diagram that illustrates various components of a computing device 300, which may embody or be included as part of the devices, systems, and/or components above, according to some embodiments. As shown in FIG. 15, the computing device 300 may include a processor circuit 310 that controls operations of the computing device 300. Although illustrated as a single processor, multiple special purpose and/or general-purpose processors and/or processor cores may be provided in the computing device 300. For example, the computing device 300 may include one or more of a video processor, a signal processor, a sound processor and/or a communication controller that performs one or more control functions within the computing device 300. The processor circuit 310 may be variously referred to as a "controller," "microcontroller," "microprocessor" or simply a "computer." The processor circuit 310 may further include one or more application-specific integrated circuits (ASICs).

Various components of the computing device 300 are illustrated in FIG. 15 as being connected to the processor circuit 310. It will be appreciated that the components may be connected to the processor circuit 310 and/or each other through one or more buses 312 including a system bus, a communication bus and controller, such as a USB controller and USB bus, a network interface, or any other suitable type of connection.

The computing device 300 further includes a memory device 314 that stores one or more functional modules 320 for performing the operations described above. Alternatively, or in addition, some of the operations described above may be performed by other devices connected to the network, such as the network 50 of the peer-to-peer wagering system 12 of FIG. 2, for example. The computing device 300 may communicate with other devices connected to the network to facilitate performance of some of these operations. For example, the computing device 300 may communicate and coordinate with certain displays to identify elements of a race being displayed by a particular display.

The memory device 314 may store program code and instructions, executable by the processor circuit 310, to control the computing device 300. The memory device 314 may include random access memory (RAM), which can include non-volatile RAM (NVRAM), magnetic RAM (ARAM), ferroelectric RAM (FeRAM) and other forms as commonly understood in the gaming industry. In some embodiments, the memory device 314 may include read only memory (ROM). In some embodiments, the memory device 314 may include flash memory and/or EEPROM (electrically erasable programmable read only memory). Any other suitable magnetic, optical and/or semiconductor memory may operate in conjunction with the gaming device disclosed herein.

The computing device 300 may include a communication adapter 326 that enables the computing device 300 to communicate with remote devices, such as the wireless network, another computing device 300, and/or a wireless access point, over a wired and/or wireless communication network, such as a local area network (LAN), wide area network (WAN), cellular communication network, or other data communication network, e.g., the network 50 of FIG. 15.

The computing device 300 may include one or more internal or external communication ports that enable the processor circuit 310 to communicate with and to operate with internal or external peripheral devices, such as a sound card 328 and speakers 330, video controllers 332, a primary display 334, a secondary display 336, input buttons 338 or other devices such as switches, keyboards, pointer devices, and/or keypads, a touch screen controller 340, a card reader 342, currency acceptors and/or dispensers, cameras, sensors such as motion sensors, mass storage devices, microphones, haptic feedback devices, and/or wireless communication devices. In some embodiments, internal or external peripheral devices may communicate with the processor through a universal serial bus (USB) hub (not shown) connected to the processor circuit 310. Although illustrated as being integrated with the computing device 300, any of the components therein may be external to the computing device 300 and may be communicatively coupled thereto. Although not illustrated, the computing device 300 may further include a rechargeable and/or replaceable power device and/or power connection to a main power supply, such as a building power supply.

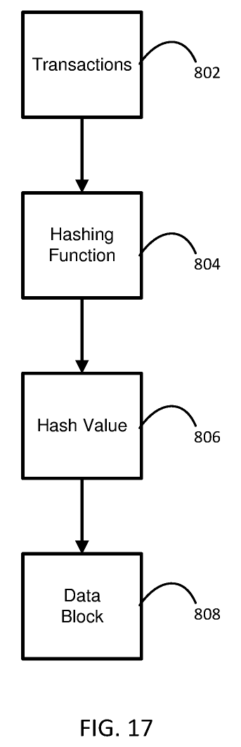

Reference is now made to FIG. 17, which is a schematic block diagram illustrating various operations for a blockchain transaction recordation according to some embodiments. As illustrated in FIG. 17, transactions 802 are occurring at various gaming casinos. In accordance with various embodiments, a hash may be created for each entry. For example, a cryptographic hash function may create a one-way, (essentially) collision free signature of the entry. The hash algorithm generates a hash. Using hashing function 804, hash values 806 are created of these transactions which are then added to data blocks 808 that are in the blockchain.

As a general principle, a validation process may be performed to ensure that the new data block meets the criteria for inclusion into the blockchain. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. other examples include a proof of work (pow) consensus algorithm and/or a proof of stake (pos) consensus algorithm, which may be used as the value of an underlying data block and/or value change.

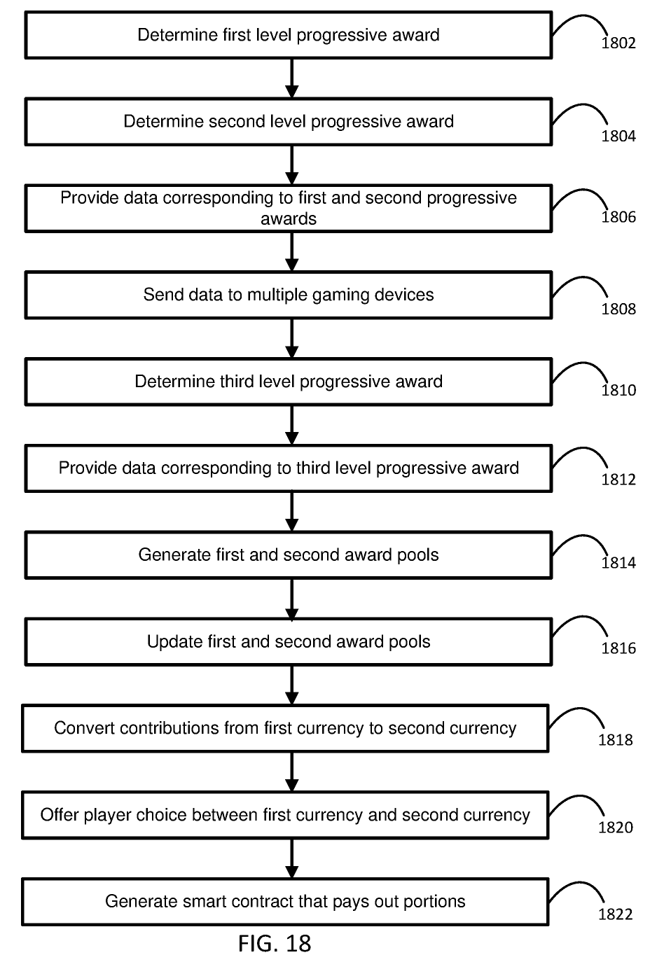

Reference is now made to FIG. 18, which is a schematic flow diagram illustrating operations of a system for a cryptocurrency denominated progressive award according to some embodiments. Operations include determining (block 1802) a first level progressive award that includes a first initial progressive award amount and a first additional amount funded by at least one of multiple wagers placed to initiate a first primary game on a first gaming device.

Operations include determining (block 1804) a second level progressive award that includes a second initial progressive award amount and a second additional amount funded by either of the at least one of the wagers placed to initiate the first primary game on the first gaming device or a second one of the wagers placed to initiate a second primary game on one of the first gaming device or a second gaming device. Operations include providing (block 1806) data corresponding to the first level progressive award and the second level progressive award to multiple gaming devices that includes the first gaming device and the second gaming device. In some embodiments, the first level progressive award is denominated in a first currency that is a base currency of a location of the first gaming machine and the second level progressive is denominated in a second currency that is different from the first currency.

In some embodiments, the second currency includes a cryptocurrency that is maintain using a decentralized distributed progressive management architecture. A non-limiting example of a decentralized distributed progressive management architecture includes Blockchain, among others.

Some embodiments include sending (block 1808) data to multiple gaming devices that includes the first gaming device and the second gaming device that causes the gaming devices to display, on a first display, the first level progressive award and, on a second display, the second level progressive award.

In some embodiments, the second display is based on an actual amount of the second currency held and an amount of first currency held in escrow to be converted into the second currency.

In some embodiments, the second display is based on a given accrual rate of the second currency.

Some embodiments provide that the second display includes data corresponding to a value change in second currency relative to first currency.

In some embodiments, the second display includes a value difference between an award level expressed in first currency and the award level expressed in the second currency.

Some embodiments include determining (block 1810) a third level progressive award that includes a third initial progressive award amount and a third additional amount funded by a wager corresponding to at least one primary game on a third gaming device and providing (block 1812) data corresponding to the third level progressive award to the gaming devices that includes the third gaming device. In some embodiments, the third level progressive is denominated in a third currency that includes a cryptocurrency and that is different from the first currency and the second currency. Data corresponding to the third level progressive amy be provided to cause the gaming devices to display, on a third display, the third level progressive award.

Some embodiments include generating (block 1814) a first award pool corresponding to the first level progressive award and a second award pool corresponding to the second level progressive award. Embodiments may further include updating (block 181816) the first award pool using the at least one of the wagers placed to initiate the first primary game on the first gaming device as the wager amount is received and the second award pool at a different interval than the update of the first award pool. In some embodiments, the second award pool is updated on a periodic interval.

In some embodiments, the second award pool is updated responsive to an escrow pool that holds a portion of the second level progressive award to be converted from the first currency to the second currency. In some embodiments, the trigger includes a game event that occurs relative to the first primary game or the second primary game.

Some embodiments include converting (block 1818) contributions corresponding to the second level progressive award from the first currency to second currency in response to a trigger.

A payout award to be paid to a player responsive to a game event in player primary game may be determined and operations may include offering (block 1820) the player a choice between the payout award in the first currency and the second currency. In some embodiments, awarding the player payout award includes transferring the second currency value to a player crypto wallet. Some embodiments provide that awarding the player payout award includes generating (block 1822) a smart contract that is implemented in a decentralized distributed progressive management architecture and that pays out portions of the second level progressive award.

In some embodiments, awarding the player payout award includes converting the second currency value into the first currency value and paying the player in first currency funds.

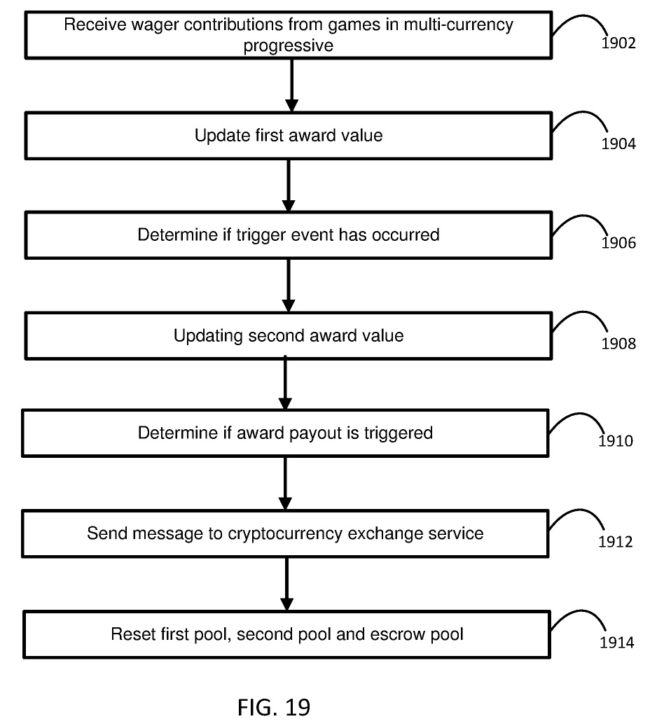

Reference is now made to FIG. 19, which is a schematic flow diagram illustrating operations of methods and system for a cryptocurrency denominated progressive award according to some embodiments. Operations include receiving (block 1902) wager contributions from multiple gaming machines that are participating in a multi-currency progressive award that includes a first level progressive award that is denominated in a first currency and a second level progressive award that is denominated in a second currency that is different from the first currency. Operations include updating (block 1904) a first award value of a first pool corresponding to the first level progressive award, determining (block 1906) if second level progressive award trigger event has occurred and, responsive to determining that the second level progressive award trigger event has occurred, updating (block 1908) a second award value of a second pool corresponding to the second level progressive award based on an escrow value in an escrow pool.

Operations include determining (block 1910) if an award payout is triggered. In response to the award payout being triggered, operations include sending (block 1912) a message to a cryptocurrency exchange management service to convert remaining first currency into the second currency. Operations further include resetting (block 1914) the first pool, second pool and escrow pool.

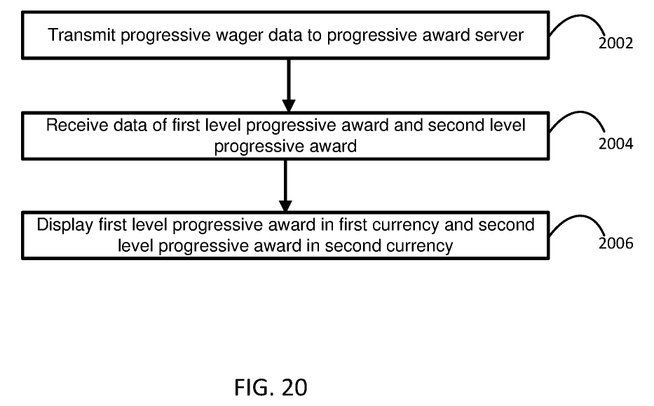

Reference is now made to FIG. 20, which is a schematic flow diagram illustrating operations of methods and systems for a cryptocurrency denominated progressive award according to some embodiments. Operations include transmitting (block 2002) progressive wager data to a progressive award server. Operations further include receiving (block 2004), from the progressive award server, data corresponding to a first level progressive award and a second level progressive award. In some embodiments, the first level progressive award is denominated in a first currency that is a base currency of a location of the gaming device and the second level progressive is denominated in a second currency that is different from the first currency. Some embodiments include displaying (block 2006) the first level progressive award in the first currency and the second level progressive award in the second currency.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro- code, etc.) or combining software and hardware implementation that may all generally be referred to herein as a "circuit," "module," "component," or "system." Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms "a", "an" and "the" are intended to include the plural forms as well, unless the context clearly indicates otherwise. It will be further understood that the terms "comprises" and/or "comprising," when used in this specification, specify the presence of stated features, steps, operations, elements, and/or components, but do not preclude the presence or addition of one or more other features, steps, operations, elements, components, and/or groups thereof. As used herein, the term "and/or" includes any and all combinations of one or more of the associated listed items and may be designated as "/". Like reference numbers signify like elements throughout the description of the figures.

In some embodiments, a device, apparatus, system and/or computer program product may be described as causing a result and/or action. In such embodiments, causing may include actually performing the action and/or result and/or as performing any action that causes another device, apparatus, system and/or computer program product to cause the result or action.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a communication interface;
a processor circuit; and
a memory coupled to the processor circuit, the memory comprising machine readable instructions that, when executed by the processor circuit, cause the processor circuit to:
determine a first level progressive award that comprises a first initial progressive award amount and a first additional amount funded by at least one of a plurality of wagers placed to initiate a first primary game on a first gaming device;
determine a second level progressive award that comprises a second initial progressive award amount and a second additional amount funded by either of the at least one of the plurality of wagers placed to initiate the first primary game on the first gaming device or a second one of the plurality of wagers placed to initiate a second primary game on one of the first gaming device or a second gaming device; and
provide data corresponding to the first level progressive award and the second level progressive award to a plurality of gaming devices that includes the first gaming device and the second gaming device, wherein the first level progressive award is denominated in a first currency that is a base currency of a location of the first gaming machine and the second level progressive is denominated in a second currency that is different from the first currency.

2. The system of claim 1, wherein the second currency comprises a cryptocurrency that is maintained using a decentralized distributed progressive management architecture.

3. The system of claim 1, wherein the processor circuit is further caused to send data to a plurality of gaming devices that includes the first gaming device and the second gaming device that causes the plurality of the gaming devices to display, on a first display, the first level progressive award and, on a second display, the second level progressive award.

4. The system of claim 3, wherein the second display is based on an actual amount of the second currency held and an amount of first currency held in escrow to be converted into the second currency.

5. The system of claim 3, wherein the second display is based on a given accrual rate of the second currency.

6. The system of claim 3, wherein the second display comprises data corresponding to a value change in second currency relative to first currency.

7. The system of claim 4, wherein the second display comprises a value difference between an award level expressed in first currency and the award level expressed in the second currency.

8. The system of claim 1, wherein the processor circuit is further caused to:
determine a third level progressive award that comprises a third initial progressive award amount and a third additional amount funded by a wager corresponding to at least one primary game on a third gaming device;
provide data corresponding to the third level progressive award to the plurality of gaming devices that comprises the third gaming device, wherein the third level progressive is denominated in a third currency that comprises a cryptocurrency and that is different from the first currency and the second currency; and
provide data corresponding to the third level progressive to cause the plurality of gaming devices to display, on a third display, the third level progressive award.

9. The system of claim 1, wherein the processor circuit is further caused to:
generate a first award pool corresponding to the first level progressive award and a second award pool corresponding to the second level progressive award.

10. The system of claim 9, wherein the processor circuit is further caused to:
update the first award pool using the at least one of the plurality of wagers placed to initiate the first primary game on the first gaming device as the wager amount is received; and
update the second award pool at a different interval than the update of the first award pool.

11. The system of claim 10, wherein the second award pool is updated on a periodic interval.

12. The system of claim 10, wherein the second award pool is updated responsive to an escrow pool that holds a portion of the second level progressive award to be converted from the first currency to the second currency.

13. The system of claim 10, where the trigger comprises a game event that occurs relative to the first primary game or the second primary game.

14. The system of claim 1, wherein the processor circuit is further caused to: convert contributions corresponding to the second level progressive award from the first currency to second currency in response to a trigger.

15. The system of claim 1, wherein the processor circuit is further caused to:
determine a payout award to be paid to a player responsive to a game event in player primary game; and
offer the player a choice between the payout award in the first currency and the second currency.

16. The system of claim 15, wherein awarding the player payout award comprises transferring the second currency value to a player crypto wallet.

17. The system of claim 15, wherein awarding the player payout award comprises generating a smart contract that is implemented in a decentralized distributed progressive management architecture and that pays out portions of the second level progressive award.

18. The system of claim 15, wherein awarding the player payout award comprises:
converting the second currency value into the first currency value; and
paying the player in first currency funds.

19. A method comprising:
receiving wager contributions from a plurality of gaming machines that are participating in a multi-currency progressive award that comprises a first level progressive award that is denominated in a first currency and a second level progressive award that is denominated in a second currency that is different from the first currency;
updating a first award value of a first pool corresponding to the first level progressive award;
determining if second level progressive award trigger event has occurred;
responsive to determining that the second level progressive award trigger event has occurred, updating a second award value of a second pool corresponding to the second level progressive award based on an escrow value in an escrow pool;
determining if an award payout is triggered;
responsive to the award payout being triggered, sending a message to a cryptocurrency exchange management service to convert remaining first currency into the second currency; and
resetting the first pool, the second pool and the escrow pool.

20. A gaming device comprising:
a communication interface;
a processor circuit; and
a memory coupled to the processor circuit, the memory comprising machine readable instructions that, when executed by the processor circuit, cause the processor circuit to:
transmit progressive wager data to a progressive award server;
receive, from the progressive award server, data corresponding to a first level progressive award and a second level progressive award, wherein the first level progressive award is denominated in a first currency that is a base currency of a location of the gaming device and the second level progressive is denominated in a second currency that is different from the first currency; and
displaying the first level progressive award in the first currency and the second level progressive award in the second currency.
